(19) United States
(12) Patent Application Publication
(10) Pub. No.: US 2015/0322386 A1
(43) Pub. Date: Nov. 12, 2015

(54) LIQUID ANTI-MICROBIAL LAUNDRY DETERGENT COMPOSITION

(71) Applicant: The Procter & Gamble Company, Cincinnati, OH (US)

(72) Inventors: Ryohei OHTANI, Nishinomiya (JP); Fei LI, Beijing (CN); Qiupeng YAO, Beijing (CN); Yoshiki ISHIDA, Singapore (SG)

(21) Appl. No.: 14/708,349

(22) Filed: May 11, 2015

(30) Foreign Application Priority Data
May 12, 2014 (WO) CN2014/077226

(51) Int. Cl. C11D 3/48; C11D 11/00; C11D 1/83; C11D 17/04; A01N 31/16; C11D 3/20

(52) U.S. Cl. CPC C11D 3/48; A01N 31/16; C11D 3/2068; C11D 1/83; C11D 17/043; C11D 11/0017

(57) ABSTRACT

A liquid anti-microbial laundry detergent composition, comprising: by weight of the composition, from 0.001% to 3% of a nonionic anti-microbial agent, and from 0.1% to 2.5% of an organic solvent that is a C₁-C₆ alcohol. The liquid anti-microbial laundry detergent composition demonstrates a good stability portfolio, as well as comparable cleaning performance.

### FIELD OF THE INVENTION

The present invention relates to a liquid anti-microbial laundry detergent composition.

### BACKGROUND OF THE INVENTION

Consumer products have evolved to address user needs for an anti-microbial benefit, in addition to their original intended functions. For example, an anti-microbial laundry detergent product is desired by users as it cleans fabrics whilst having an anti-microbial benefit on fabrics. Currently, the typical approach to deliver an anti-microbial benefit is the incorporation of anti-microbial agents into the consumer product formulations. Such anti-microbial agents either damage the bacteria envelope to kill bacteria, or denature the bacteria envelope to prevent bacteria growth or reproduction, thereby delivering the anti-microbial benefit.

When incorporated into a liquid laundry detergent composition, many known anti-microbial agents pose stability challenges. For example, lauryl trimethyl ammonium chloride, which is a traditional cationic anti-microbial agent, has compatibility issue with anionic surfactants that are typically present in a laundry detergent composition. In order to alleviate the compatibility issue, the art teaches formulating relatively high levels of solvents or stabilizers into the composition. This high level of solvents or stabilizers dilutes the surfactant level in the composition and therefore causes poor cleaning performance. Also, the increased level of solvents or stabilizers leads to undesired rising cost.

Thus, there is a need for a liquid anti-microbial laundry detergent composition that demonstrates a good stability portfolio, whilst maintaining comparable cleaning performance.

It is an advantage of the present invention to provide a stable liquid anti-microbial laundry detergent composition that enables a minimized level of solvents or stabilizers. In particular, the present invention allows for a stable, concentrated liquid anti-microbial laundry detergent composition.

### SUMMARY OF THE INVENTION

The present invention is directed to a liquid anti-microbial laundry detergent composition, comprising:

a) from 0.001% to 3%, by weight of the composition, of a nonionic anti-microbial agent; and

b) from 0.1% to 2.5%, by weight of the composition, of an organic solvent, wherein the organic solvent is a C₁-C₆ alcohol.

### DETAILED DESCRIPTION OF THE INVENTION

### Definitions

As used herein, the term “laundry detergent composition” means a composition relating to cleaning fabrics. The term “liquid laundry detergent composition” herein refers to compositions that are in a form selected from the group consisting of pourable liquid, gel, cream, and combinations thereof. The liquid laundry detergent composition may be either aqueous or non-aqueous, and may be anisotropic, isotropic, or combinations thereof.

As used herein, the term “anti-microbial agent” refers to a chemical compound of which the principle intended function is to kill bacteria or to prevent their growth or reproduction. Traditional anti-microbial agents include cationic anti-microbial agents (e.g., certain ammonium chlorides), nonionic anti-microbial agents, etc. Diphenyl ether compounds that are preferably used in the present invention are nonionic anti-microbial agents.

As used herein, the term “washing solution” refers to the typical amount of aqueous solution used for one cycle of laundry washing, preferably from 1 L to 50 L, alternatively from 1 L to 20 L for hand washing and from 20 L to 50 L for machine washing.

As used herein, the term “alkyl” means a hydrocarbyl moiety which is branched or unbranched, substituted or unsubstituted. Included in the term “alkyl” is the alkyl portion of acyl groups.

As used herein, when a composition is “substantially free” of a specific ingredient, it is meant that the composition comprises less than a trace amount, alternatively less than 0.1%, alternatively less than 0.01%, alternatively less than 0.001%, by weight of the composition, of the specific ingredient.

As used herein, the articles including “a” and “an” when used in a claim, are understood to mean one or more of what is claimed or described.

As used herein, the terms “comprise”, “comprises”, “comprising”, “include”, “includes”, “including”, “contain”, “contains”, and “containing” are meant to be non-limiting, i.e., other steps and other ingredients which do not affect the end of result can be added. The above terms encompass the terms “consisting of” and “consisting essentially of”.

### Liquid Anti-microbial Laundry Detergent Composition

The liquid anti-microbial laundry detergent composition of the present invention comprises, by weight of the composition, from 0.001% to 3% of a nonionic anti-microbial agent, and from 0.1% to 2.5% of an organic solvent of a C₁-C₆ alcohol. It has been surprisingly found that, by selecting a particular type of anti-microbial agent, the liquid composition of the present invention demonstrates a good stability portfolio without having to compromise its cleaning performance. Without wishing to be bound by theory, it is believed that due to its nonionic property, the anti-microbial agent of the present invention allows for a stable, liquid anti-microbial laundry detergent composition, in the presence of a relatively low level of the solvents. By contrast, in such a context of low level of solvents, traditional cationic anti-microbial agents are not compatible with anionic surfactants present in the laundry detergent compositions. Thus, traditional cationic anti-microbial agents cannot achieve a stable liquid composition without utilizing a relatively high level of solvents, which leads to a diluted surfactant level and poor cleaning performance. In other words, it is challenging to obtain both good stability and cleaning performance with the traditional cationic anti-microbial agents.

Preferably in the liquid laundry detergent composition, the nonionic anti-microbial agent is present from 0.01% to 1%, more preferably from 0.03% to 0.5%, by weight of the composition. The organic solvent is preferably present from 0.2% to 2%, more preferably from 0.3% to 1.5%, by weight of the composition.

In a laundry washing solution, the liquid laundry detergent composition is preferably capable of delivering the anti-microbial agent at a level from 0.01 ppm to 5 ppm, more preferably from 0.05 ppm to 3 ppm, more preferably from 0.1 ppm to 1 ppm.

The laundry detergent composition herein provides anti-microbial benefits against both Gram positive bacteria (e.g., Staphylococcus aureus) and Gram negative bacteria (e.g., Klebsiella pneumoniae). The composition preferably provides residual anti-microbial benefits to the fabrics treated by the composition, i.e., the nonionic anti-microbial agent therein deposits onto the fabrics during a washing cycle and subsequently the deposited (i.e., residual) antimicrobial-agent prevents bacteria growth onto the fabrics during drying or storage or wear. In one embodiment, the laundry detergent composition provides a Bacteriostatic Activity Value of at least a log 2.2 reduction, preferably a log 2.5 reduction, against both Gram positive bacteria and Gram negative bacteria, to treated fabrics versus non-treated fabrics. Preferably, the composition provides at least a log 2.2 reduction, preferably a log 2.5 reduction, against Staphylococcus aureus and/or Klebsiella pneumoniae after a 10 minutes contact time in a 2069 ppm aqueous solution as determined by the JISL 1902 method (that is described below). More preferably, the composition provides at least a log 3.0 reduction, preferably a log 3.5 reduction, against Staphylococcus aureus. It is worth noting that Staphylococcus aureus is frequently found on human skin and therefore fabrics (particularly wearing fabrics) are in particular need of anti-microbial effects against Staphylococcus aureus.

The laundry detergent composition herein may be acidic or alkali or pH neutral, depending on the ingredients incorporated in the composition. The pH range of the laundry detergent composition is preferably from 6 to 12, more preferably from 7 to 11, even more preferably from 8 to 10.

The liquid laundry detergent composition can have any suitable viscosity depending on factors such as formulated ingredients and purpose of the composition. In one embodiment, the composition has a high shear viscosity value, at a shear rate of 20/sec and a temperature of 21° C., of 200 to 3,000 cP, alternatively 300 to 2,000 cP, alternatively 500 to 1,000 cP, and a low shear viscosity value, at a shear rate of 1/sec and a temperature of 21° C., of 500 to 100,000 cP, alternatively 1000 to 10,000 cP, alternatively 1,500 to 5,000 cP.

Nonionic Anti-microbial Agent

The nonionic anti-microbial agent of the present invention is preferably a diphenyl ether, more preferably is a hydroxyl diphenyl ether. The nonionic anti-microbial agent herein can be either halogenated or non-halogenated, but preferably is halogenated. Diphenyl ethers suitable for use herein are described from Col. 1, line 54 to Col. 5, line 12 in U.S. Pat. No. 7,041,631B, which is incorporated by reference.

In one embodiment, the nonionic anti-microbial agent is a hydroxyl diphenyl ether of formula (I):

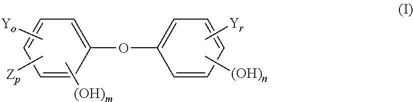

wherein:

each Y is independently selected from chlorine, bromine, or fluorine, preferably is chlorine or bromine, more preferably is chlorine,

each Z is independently selected from SO₂H, NO₂, or C₁-C₄ alkyl,

r is 0, 1, 2, or 3, preferably is 1 or 2,

o is 0, 1, 2, or 3, preferably is 0, 1 or 2,

p is 0, 1, or 2, preferably is 0,

m is 1 or 2, preferably is 1, and

n is 0 or 1, preferably is 0.

In the above definition for formula (I), 0 means nil. For example, when p is 0, then there is no Z in formula (I). Each Y or Z could be the same or different. In one embodiment, o is 1, r is 2, and Y is chlorine or bromine This embodiment could be: one chlorine atom bonds to a benzene ring while the bromine atom and the other chlorine atom bond to the other benzene ring; or the bromine atom bonds to a benzene ring while the two chlorine atoms bond to the other benzene ring.

Preferably, the nonionic anti-microbial agent herein is selected from the group consisting of 4-4′-dichloro-2-hydroxy diphenyl ether (“Diclosan”), 2,4,4′-trichloro-2′-hydroxy diphenyl ether (“Triclosan”), and a combination thereof. Most preferably, the anti-microbial agent is 4-4′-dichloro-2-hydroxy diphenyl ether, commercially available from BASF, under the trademark name Tinosan® HP100.

In addition to the diphenyl ether, other anti-microbial agents may also be present, provided that these are not present at a level which causes instability in the formulation. Among such useful further antimicrobial agents are chelating agents, which are particularly useful in reducing the resistance of Gram negative microbes in hard water. Acid biocides may also be present.

Organic Solvent

The organic solvent of the present invention is a C₁-C₆ alcohol, preferably C₂-C₆ alcohol. The alcohol herein is preferably selected from the group consisting of diol, triol, and a combination thereof. In one embodiment, the alcohol is an alkanolamine, including methanolamine, ethanolamine, propaneolamine, etc. Preferably, the organic solvent is selected from the group consisting of ethanol, ethylene glycol, diethylene glycol, propylene glycol, glycerol, ethanolamine (such as mono-, di-, and tri-ethanolamine), and a combination thereof. More preferably, the organic solvent is selected from the group consisting of diethylene glycol, propylene glycol, glycerol, monoethanolamine, triethanolamine, and a combination thereof. Most preferably, the organic solvent is propylene glycol.

In addition to the C₁-C₆ alcohol, the liquid laundry detergent composition herein may also comprise a hydrotrope, which could also be considered as a solvent. It is worth noting that, the level of 0.1% to 2.5% as required for the organic solvent of C₁-C₆ alcohol does not count the level of a hydrotrope that may also be present in the composition. The hydrotrope is preferably selected from the group consisting of sodium cumene sulfonate (SCS), sodium toluene sulfonate (NaTS), sodium xylene sulfonate (SXS), and a combination thereof. More preferably, the hydrotrope is SCS.

In one preferred embodiment, the liquid anti-microbial laundry detergent composition comprises:

a) from 0.03% to 0.5%, by weight of the composition, of a nonionic anti-microbial agent, wherein the anti-microbial agent is 4-4′-dichloro-2-hydroxy diphenyl ether; and

b) from 0.3% to 1.5%, by weight of the composition, of an organic solvent, wherein the organic solvent is propylene glycol.

### Adjunct Ingredients

The liquid anti-microbial laundry detergent composition herein may comprise adjunct ingredients. Suitable adjunct materials include but are not limited to: anionic surfactants, nonionic surfactants, cationic surfactants, amphoteric surfactants, builders, chelating agents, rheology modifiers, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, photobleaches, perfumes, perfume microcapsules, structure elasticizing agents, fabric softeners, carriers, processing aids, hueing agents, structurants and/or pigments. In addition to the disclosure below, suitable examples of such other adjuncts and levels of use are found in U.S. Pat. Nos. 5,576,282, 6,306,812 B1 and 6,326,348 B1 that are incorporated by reference. The precise nature of these adjunct ingredients and the levels thereof in the laundry detergent composition will depend on the physical form of the composition and the nature of the cleaning operation for which it is to be used.

In one embodiment, the liquid laundry detergent composition herein further comprises a surfactant selected from the group consisting of anionic surfactant, nonionic surfactant, cationic surfactant, amphoteric surfactant, and a combination thereof. Preferably the composition comprises from 3% to 50%, by weight of the composition, of an anionic surfactant, and from 0.1% to 10%, by weight of the composition, of a nonionic surfactant.

In one embodiment, the composition comprises an anionic surfactant. Non-limiting examples of anionic surfactants include: linear alkylbenzene sulfonate (LAS), preferably C₁₀-C₁₆ LAS; C₁₀-C₂₀ primary, branched-chain and random alkyl sulfates (AS); C₁₀-C₁₈ secondary (2,3) alkyl sulfates; sulphated fatty alcohol ethoxylate (AES), preferably C₁₀-C₁₈ alkyl alkoxy sulfates (AEₓS) wherein preferably x is from 1-30, more preferably x is 1-3; C₁₀-C₁₈ alkyl alkoxy carboxylates preferably comprising 1-5 ethoxy units; mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303; modified alkylbenzene sulfonate (MLAS) as discussed in WO 99/05243, WO 99/05242, and WO 99/05244; methyl ester sulfonate (MES);

and alpha-olefin sulfonate (AOS). Preferably, the composition comprises an anionic surfactant selected from the group consisting of LAS, AES, AS, and a combination thereof, more preferably selected from the group consisting of LAS, AES, and a combination thereof. The total level of the anionic surfactant(s) may be from 3% to 50%, preferably present from 5% to 40%, more preferably from 10% to 30%, by weight of the composition, in the composition, by weight of the liquid detergent composition. In the execution where both AES and LAS are present in the composition, the weight ratio of the AES to LAS is from 0.1:1 to 10:1, preferably from 0.5:1 to 5:1, more preferably from 0.7:1 to 2:1.

In the present invention, since the level of the organic solvent is relatively low, the composition herein allows for the incorporation of a relatively high level of anionic surfactants (i.e., concentrated composition) without causing a stability concern. In one embodiment, the composition comprises:

a) from 0.001% to 0.3%, by weight of the composition, of a nonionic anti-microbial agent;

b) from 0.3% to 1.5%, by weight of the composition, of an organic solvent, wherein the organic solvent is C₁-C₆ alcohol; and

c) from 20% to 50%, by weight of the composition, of the anionic surfactant, wherein the anionic surfactant is selected from the group consisting of AES, LAS, and a combination thereof.

In one embodiment, the composition herein comprises a nonionic surfactant, preferably an alkoxylated nonionic surfactant. Non-limiting examples of alkoxylated nonionic surfactants suitable for use herein include: C₁₂-C₁₈ alkyl ethoxylates, such as Neodol® nonionic surfactants available from Shell; C₆-C₁₂ alkyl phenol alkoxylates wherein the alkoxylate units are a mixture of ethyleneoxy and propyleneoxy units; C₁₂-C₁₈ alcohol and C₆-C₁₂ alkyl phenol condensates with ethylene oxide/propylene oxide block alkyl polyamine ethoxylates such as Pluronic® available from BASF; C₁₄⁻C₂₂ mid-chain branched alkyl alkoxylates, BAEx, wherein x is from 1-30, as discussed in U.S. Pat. No. 6,153,577, U.S. Pat. No. 6,020,303 and U.S. Pat. No. 6,093,856; alkylpolysaccharides as discussed in U.S. Pat. No. 4,565,647 Llenado; specifically alkylpolyglycosides as discussed in U.S. Pat. No. 4,483,780 and U.S. Pat. No. 4,483,779; polyhydroxy fatty acid amides as discussed in U.S. Pat. No. 5,332,528; and ether capped poly(oxyalkylated) alcohol surfactants as discussed in U.S. Pat. No. 6,482,994 and WO 01/42408. Also useful herein as nonionic surfactants are alkoxylated ester surfactants such as those having the formula R¹C(O)O(R₂O)nR³ wherein R¹ is selected from linear and branched C₆-C₂₂ alkyl or alkylene moieties; R² is selected from C₂H₄ and C₃H₆ moieties and R³ is selected from H, CH₃, C₂H₅ and C₃H₇ moieties; and n has a value between 1 and 20. Such alkoxylated ester surfactants include the fatty methyl ester ethoxylates (MEE) and are well-known in the art; see for example U.S. Pat. No. 6,071,873; U.S. Pat. No. 6,319,887; U.S. Pat. No. 6,384,009; U.S. Pat. No. 5,753,606; WO 01/10391, WO 96/23049.

In one embodiment, the alkoxylated nonionic surfactant herein is C₆-C₂₂ alkoxylated alcohol, preferably C₈-C₁₈ alkoxylated alcohol, more preferably C₁₂-C₁₆ alkoxylated alcohol. The C₆-C₂₂ alkoxylated alcohol is preferably an alkyl alkoxylated alcohol with an average degree of alkoxylation of from 1 to 50, preferably 3 to 30, more preferably from 5 to 20, even more preferably from 5 to 9. The alkoxylation herein may be ethoxylation, propoxylation, or a mixture thereof, but preferably is ethoxylation. In one embodiment, the alkoxylated nonionic surfactant is C₆⁻C₂₂ ethoxylated alcohol, preferably C₈-C₁₈ alcohol ethoxylated with an average of 5 to 20 moles of ethylene oxides, more preferably C₁₂-C₁₆ alcohol ethoxylated with an average of 5 to 9 moles of ethylene oxides. The most preferred alkoxylated nonionic surfactant is C₁₂-C₁₅ alcohol ethoxylated with an average of 7 moles of ethylene oxide, e.g., Neodol®25-7 commercially available from Shell.

In one embodiment, the composition herein comprises a cationic surfactant. Non-limiting examples of cationic surfactants include: the quaternary ammonium surfactants, which can have up to 26 carbon atoms include: alkoxylate quaternary ammonium (AQA) surfactants as discussed in U.S. Pat. No. 6,136,769; dimethyl hydroxyethyl quaternary ammonium as discussed in U.S. Pat. No. 6,004,922; dimethyl hydroxyethyl lauryl ammonium chloride; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660 4,260,529 and U.S. Pat. No. 6,022,844; and amino surfactants as discussed in U.S. Pat. No. 6,221,825 and WO 00/47708, specifically amido propyldimethyl amine (APA).

In one embodiment, the composition herein comprises an amphoteric surfactant. Non-limiting examples of amphoteric surfactants include: derivatives of secondary and tertiary amines, derivatives of heterocyclic secondary and tertiary amines, or derivatives of quaternary ammonium, quaternary phosphonium or tertiary sulfonium compounds. Preferred examples include: betaine, including alkyl dimethyl betaine and cocodimethyl amidopropyl betaine, C8 to C18 (or C12 to C18) amine oxides and sulfo and hydroxy betaines, such as N-alkyl-N,N-dimethylammino-1-propane sulfonate where the alkyl group can be C8 to C18, or C10 to C14.

Preferably, the amphoteric surfactant herein is selected from water-soluble amine oxide surfactants. A useful amine oxide surfactant is:

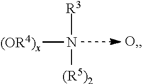

where R³ is a C₈₋₂₂ alkyl, a C₈₋₂₂ hydroxyalkyl, or a C₈₋₂₂ alkyl phenyl group; each R⁴ is a C₂₋₃ alkylene, or a C₂₋₃₂ hydroxyalkylene group; x is from 0 to about 3; and each R⁵ is a C₁₋₃ alkyl, a C₁₋₃ hydroxyalkyl, or a polyethylene oxide containing from about 1 to about 3 EOs. Preferably, the amine oxide surfactant may be a C₁₀₋₁₈ alkyl dimethyl amine oxide or a C₈₋₁₂ alkoxy ethyl dihydroxy ethyl amine oxide.

In one embodiment, the composition herein comprises a rheology modifier (also referred to as a “structurant” in certain situations), which functions to suspend and stabilize the microcapsules and to adjust the viscosity of the composition so as to be more applicable to the packaging assembly. The rheology modifier herein can be any known ingredient that is capable of suspending particles and/or adjusting rheology to a liquid composition, such as those disclosed in U.S. Patent Application Nos. 2006/0205631A1, 2005/0203213A1, and U.S. Pat. Nos. 7,294,611, 6,855,680. Preferably the rheology modifier is selected from the group consisting of hydroxy-containing crystalline material, polyacrylate, polysaccharide, polycarboxylate, alkali metal salt, alkaline earth metal salt, ammonium salt, alkanolammonium salt, C₁₂-C₂₀ fatty alcohol, di-benzylidene polyol acetal derivative (DBPA), di-amido gallant, a cationic polymer comprising a first structural unit derived from methacrylamide and a second structural unit derived from diallyl dimethyl ammonium chloride, and a combination thereof. Preferably, the rheology modifier is a hydroxy-containing crystalline material generally characterized as crystalline, hydroxyl-containing fatty acids, fatty esters and fatty waxes, such as castor oil and castor oil derivatives. More preferably the rheology modifier is a hydrogenated castor oil (HCO).

In a highly preferred embodiment, the anti-microbial laundry detergent composition of the present invention comprises:

a) from 0.03% to 0.5%, by weight of the composition, of a nonionic anti-microbial agent, wherein the anti-microbial agent is 4-4′-dichloro-2-hydroxy diphenyl ether;

b) from 0.3% to 1.5%, by weight of the composition, of an organic solvent, wherein the organic solvent is propylene glycol;

c) from 10% to 30%, by weight of the composition, of the anionic surfactant, wherein the anionic surfactant is selected from the group consisting of AES, LAS, and a combination thereof; and

d) from 0.5% to 5%, by weight of the composition, of a nonionic surfactant, wherein the nonionic surfactant is C₁₂-C₁₆ alcohol ethoxylated with an average of 5 to 9 moles of ethylene oxides.

### Composition Preparation

The liquid anti-microbial laundry detergent composition of the present invention is generally prepared by conventional methods such as those known in the art of making liquid laundry detergent compositions. Such methods typically involve mixing the essential and optional ingredients in any desired order to a relatively uniform state, with or without heating, cooling, application of vacuum, and the like, thereby providing laundry detergent compositions containing ingredients in the requisite concentrations.

### Water-Soluble Pouch

In one embodiment, the liquid anti-microbial laundry detergent composition herein is contained within a water-soluble film thereby forming a water-soluble pouch. The pouch may be of such a size that it conveniently contains either a unit dose amount of the composition herein, suitable for the required operation, for example one wash, or only a partial dose, to allow a user greater flexibility to vary the amount used, e.g., depending on the size or degree of soiling of the wash load.

The water-soluble film of the pouch preferably comprises a polymer. The film can be obtained from methods known in the art, e.g., by casting, blow molding, extrusion molding, injection molding of the polymer. Non-limiting examples of the polymer for making the water-soluble film include: polyvinyl alcohols (PVAs), polyvinyl pyrrolidone, polyalkylene oxides, (modified) cellulose, (modified) cellulose-ethers or -esters or -amides, polycarboxylic acids and salts including polyacrylates, copolymers of maleic/acrylic acids, polyaminoacids or peptides, polyamides including polyacrylamide, polysaccharides including starch and gelatine, natural gums such as xanthum and carragum. Preferably, the water-soluble film comprises a polymer selected from the group consisting of polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, polyvinyl alcohols, hydroxypropyl methyl cellulose (HPMC), and a combination thereof. Most preferably, the water-soluble film comprises polyvinyl alcohol, e.g., M8639 available from MonoSol. Suitable polymers for making the water-soluble film of the pouch can be found in U.S. Pat. No. 6,995,126.

The pouch herein may comprise a single compartment or multiple compartments, preferably comprise multiple compartments, e.g., two compartments or three compartments. In the multi-compartment execution, one or more of the multiple compartments comprise the aforementioned liquid anti-microbial laundry detergent composition. Preferably, the pouch comprises multiple films which form the multiple compartments, i.e., the inner volume of the multiple films is divided into the multiple compartments. Examples of these multi-compartment pouches are described in U.S. Pat. Nos. 4,973,416, 5,224,601, and 8,066,818.

The pouch of the present invention can be made by any suitable processes known in the art. Example processes of making the pouch can be found in U.S. Pat. Nos. 6,995,126, 7,127,874, 8,156,713, 7,386,971, 7,439,215, and US Patent Publication No. 2009/199877.

### Method of Use

Another aspect of the present invention is directed to a method of using the laundry detergent composition to treat a fabric with an anti-microbial benefit. The method comprises the step of administering from 5 g to 120 g of the aforementioned laundry detergent composition into a laundry washing basin comprising water to form a washing solution. The washing solution in a laundry washing basin herein preferably has a volume from 1 L to 50 L, alternatively from 1 L to 20 L for hand washing and from 20 L to 50 L for machine washing. Preferably, the anti-microbial benefit herein is determined by the JISL 1902 method. The temperatures of the laundry washing solution preferably range from 5° C. to 60° C.

The dosing amount in the method herein may be different depending on the washing type.

In one embodiment, the method comprises administering from 5 g to 60 g of the laundry detergent composition into a hand washing basin (e.g., 4 L). In an alternative embodiment, the method comprises administering from 60 g to 120 g of the laundry detergent composition into a washing machine (e.g., 30 L).

Preferably, the method herein further comprises the step of contacting a fabric with the washing solution, wherein the fabric is in need of an anti-microbial treatment. For example, the presence of Gram positive bacteria and/or Gram negative bacteria is suspected on the fabric. The step of contacting the fabric with the washing solution is preferably after the step of administering the laundry detergent composition in a laundry washing basin. The method may further comprise the step of contacting a fabric with the laundry detergent composition prior to the step of administering the laundry detergent composition in a laundry washing basin, i.e., pre-treat the fabric with the laundry detergent composition for certain time, preferably from 1 minute to 10 minutes.

### Test Method

The anti-microbial efficacy for laundry detergent compositions is determined by the method as defined in the JISL 1902 method and described hereinafter.

1. Microorganism Preparation:

A. Aseptically add certain amount of nutrient broth into a lyophilized culture of Staphylococcus aureus or Klebsiella pneumoniae. Dissolve and suspend the culture in the nutrient broth to obtain a suspension. Streak a loop of the suspension onto a nutrient agar plate, and incubate at 37° C. for 24 hours to obtain a first generation subculture of bacterial suspension. Transfer a loop of the first generation subculture of bacterial suspension into 20 mL of nutrient broth with shaking, and incubate at 37° C. for 24 hours to obtain a second generation subculture of bacterial suspension. Transfer 0.4 mL of the second generation subculture of bacterial suspension into another 20 mL of nutrient broth with shaking, and incubate at 37° C. for 3 hours to obtain a third generation subculture of bacterial suspension.

B. Dilute the third generation subculture of bacterial suspension by 1/20 diluted nutrient broth to 1×105 cells/mL to obtain a working culture.

C. Store the working culture at 4° C. The working culture cannot be stored overnight.

2. Fabric Washing:

A. Boil two fabric strips each having a width of 5 cm and length of 2.5 m (32 yarn/cm×32 yarn/cm, 100% plain weave cotton) in 3 L of a solution for 1 hour. The solution is prepared by 1.5 g of a nonionic soaked agent, 1.5 g of sodium carbonate, and 3000 mL of distilled water. The nonionic soaked agent is prepared by 5.0 g of alkylphenol ethoxylate, 5 g of sodium carbonate, and 1000 mL of distilled water. Rinse the fabric strips in boiled deionized water for 5 minutes. Place the fabric strips in cool deionized water for 5 minutes, and indoor dry. One fabric strip serves as a test fabric strip for following steps 2B-2I, and the other fabric strip is used as control (without experiencing steps 2B-2I).

B. Fix one end of the test fabric strip obtained from step 2A onto a stainless steel spindle at an outer position along the horizontal extension of the stainless steel spindle. The stainless steel spindle has 3 horizontal stands that are connected to one another. Wrap the test fabric strip around the 3 horizontal stands of the stainless steel spindle with sufficient tension to obtain a fabric wrapped spindle having 12 laps of fabric. Fix the other end of the test fabric strip onto the outer lap of the 12 laps of fabric via a pin. Sterilize the fabric wrapped spindle with pressure steam at 121° C. for 15 minutes.

C. Dissolve 5.903 g of calcium chloride dihydrate and 2.721 g of magnesium chloride hexahydrate in 100 mL of distilled water, and then sterilize the mixture with pressure steam at 121° C. for 20 minutes. Add 1 mL of the mixture into 1L of distilled water to obtain a hard water solution.

D. Add sufficient amount of sample into 1 L of the hard water solution obtained from step 2C to obtain a solution having a concentration of 2069 ppm. Mix the solution by a magnetic stirrer for 4 minutes. Distribute 250 mL of the mixed solution into an exposure chamber to obtain a washing solution. Place the exposure chamber in a water bath and achieve the test temperature of (25±1)° C. The exposure chamber is then sterilized with pressure steam at 121° C. for 15 minutes.

E. Aseptically soak the fabric wrapped spindle obtained from step 2B into the washing solution in the exposure chamber, and close the exposure chamber with a lid.

F. Fix the exposure chamber onto a tumbler. Rotate the tumbler for 10 minutes. Then remove the fabric wrapped spindle from the exposure chamber. Place the fabric wrapped spindle in Haier iwash-lp Top Load Washing Machine and rinse for 2 minutes.

G. Discard the washing solution from the exposure chamber, and then add 250 mL of sterilized distilled water into the exposure chamber. Soak the rinsed fabric wrapped spindle in the newly added distilled water in the exposure chamber. Rotate the tumbler for 3 minutes.

H. Repeat step 2G.

I. Aseptically remove the fabric wrapped spindle out of the exposure chamber and remove the test fabric strip from the spindle. Air dry the test fabric strip overnight.

3. Fabric Incubation:

A. Cut the washed test fabric strip obtained from step 21 to square pieces having a side length of 2 cm. 3 sets of 0.4 g of the pieces serve as specimens for the following steps.

B. Put each set of specimens into a vial, and then sterilize the specimens with pressure steam at 121° C. for 15 minutes. After the sterilization, dry the specimens for 1 hour in a clean bench without a cap.

C. Inoculate 0.2 mL of the working culture obtained from step 1C onto each dried specimen. Incubate the vials containing the inoculated specimens at 37° C. for 18 hours.

D. Extract survivors on the incubated specimens, plate with nutrient agar, and incubate at 37° C. for 24-48 hours. Count the total colony-forming units (CFU) of each set of specimens, and obtain average results of the 3 sets. Take the log10 value of CFU value as Mb.

E. In steps 3A-3D, use the fabric strip obtained from step 2A (that does not experience steps 2B-2I) as control. Take the log 10 value of CFU value as Ma.

4. Calculation of Bacteriostatic Activity Value:

Bacteriostatic Activity Value=Mb−Ma

A Bacteriostatic Activity Value of greater than 2.2 represents acceptable anti-microbial efficacy, of greater than 2.5 represents good anti-microbial efficacy, and of greater than 3.0 represents excellent anti-microbial efficacy. And a Bacteriostatic Activity Value of lower then 2.2 indicates unacceptable poor anti-microbial efficacy.

### Example

The Examples herein are meant to exemplify the present invention but are not used to limit or otherwise define the scope of the present invention. Examples 1A-1C and 2A are examples according to the present inventions, and Example 2B is comparative example.

### Examples 1A-1C: Formulations of Liquid Laundry Detergent Compositions

The following liquid laundry detergent compositions shown in Table 1 are made comprising the listed ingredients in the listed proportions (weight %).

TABLE 1

| | 1A | 1B | 1C |
|---|---|---|---|
| C₁₂-₁₄AE₁₋₃S | 13 | 8.3 | 10 |
| C₁₁-₁₃LAS | 3 | 5.5 | 6.5 |
| Neodol ®25-7 a | 1.4 | 1.2 | 1.4 |
| Citric acid | 0 | 2 | 1.7 |
| Boric acid | 0 | 2 | 1.9 |
| C₁₂-C₁₈ fatty acid | 1.5 | 1.2 | 1.3 |
| Na-DTPA b | 0.06 | 0.2 | 0.4 |
| Propylene glycol | 0.3 | 0.5 | 1.0 |
| Calcium chloride | 0 | 0 | 0.06 |
| Silicone emulsion | 0 | 0.0025 | 0.0025 |
| Monoethanolamine | 0.07 | 0 | 0 |
| Sodium polyacrylate | 1.4 | 0 | 0 |
| NaOH | Up to pH 8 | Up to pH 8 | Up to pH 8 |
| Tinosan ®HP100 c | 0.04 | 0.08 | 0.12 |
| Brightener | 0 | 0.06 | 0.06 |
| Protease | 0 | 0 | 0.45 |
| Amylase | 0 | 0 | 0.08 |
| Dye | 0 | 0.002 | 0.002 |
| Perfume oil | 0 | 0.6 | 0.6 |
| Water | Add to 100 | Add to 100 | Add to 100 |

a Neodol ®25-7 is C₁₂-C₁₅ alcohol ethoxylated with an average of 7 moles of ethylene oxide as a nonionic surfactant, available from Shell
b penta sodium salt diethylene triamine penta acetic acid as a chelant
c Tinosan ®HP100 is 4-4′-dichloro-2-hydroxy diphenyl ether, available from BASF

### Example 2A-2B: Formulations of Liquid Laundry Detergent Compositions

The following liquid laundry detergent compositions shown in Table 2 are made comprising the listed ingredients in the listed proportions (weight %).

TABLE 2

| | 2A | Comparative 2B |
|---|---|---|
| C₁₁-C₁₃ LAS | 9.1 | 9.1 |
| C₁₂-C₁₄AE₃S | 1.2 | 1.2 |
| Surfonic ®L24-9 a | 4.2 | 4.2 |
| Boric acid | 1.3 | 1.3 |
| Citric acid | 1.2 | 1.2 |
| C₁₂-C₁₈ fatty acid | 2.5 | 2.5 |
| Na-DTPMP b | 0.4 | 0.4 |
| Propylene glycol | 0.3 | 0.3 |
| Sodium cumene sulphonate | 1.3 | 1.3 |
| NaOH | 1.8 | 1.8 |
| Brightener | 0.5 | 0.5 |
| Tinosan ®HP100 c | 0.17 | 0 |
| Cationic anti-microbial agent d | 0 | 0.86 |
| Perfume oil | 0.2 | 0.2 |
| Water | Add to 100 | Add to 100 |

a Surfonic ®L24-9 is C₁₂-C₁₄ alcohol ethoxylated with 9 moles of ethylene oxide as a nonionic surfactant, available from Huntsman
b sodium salt diethylene triamine penta methylene phosphonic acid as a chelant
c Tinosan ®HP100 is 4-4′-dichloro-2-hydroxy diphenyl ether, available from BASF
d The cationic anti-microbial agent used herein is lauryl trimethyl ammonium chloride

Preparation of the liquid laundry detergent compositions of Examples 1A-1C and 2A-2B

The liquid laundry detergent compositions of Examples 1A-1C and 2A-2B are prepared by the following steps:

a) mixing a combination of NaOH and water in a batch container by applying a shear of 200 rpm;

b) adding citric acid (if any), boric acid (if any), and C₁₁-C₁₃ LAS into the batch container, keeping on mixing by applying a shear of 200 rpm;

c) cooling down the temperature of the combination obtained in step b) to 25° C.;

d) adding C₁₂₋₁₄AE₁₋₃S, Na-DTPA (if any), Na-DTPMP (if any), Neodol® 25-7 (if any), Surfonic® L24-9 (if any), C₁₂-C₁₈ fatty acid, propylene glycol, monoethanolamine (if any), calcium chloride (if any), sodium cumene sulphonate (if any), silicone emulsion (if any), sodium polyacrylate (if any), Tinosan® HP100 (if any), and cationic anti-microbial agent (if any), into the batch container, mixing by applying a shear of 250 rpm until the combination is homogeneously mixed, and adjusting pH to 8;

e) adding brightener (if any), protease (if any), amylase (if any), dye (if any), and perfume oil (if any) into the batch container, mixing by applying a shear of 250 rpm, thus forming a liquid laundry detergent composition, thus forming a liquid laundry detergent composition,

wherein each ingredient in the composition is present in the level as specified for Examples 1A-1C and 2A-2B in Tables 1 and 2.

Stability Assessment

Comparative experiments of assessing the physical stability of the liquid laundry detergent compositions of Example 2A and Comparative Example 2B, are conducted. Specifically, the stability is assessed 1) when the compositions are freshly made at 25° C. and 2) when the compositions follow a freeze-thaw cycle, using visual assessment of any changes. The freeze-thaw cycle comprises a first step at 18° C. for 24 hours followed by a second step at 25° C. for 24 hours. The assessment results of the compositions are shown in Table 3.

TABLE 3

| | 2A | 2B |
|---|---|---|
| Fresh | Clear, transparent | Milky, opaque |
| Freeze Thaw | Stable | Phase separation |

As shown in Table 3, the liquid laundry detergent composition according to the present invention that comprises Tinosan® HP100 (Example 2A) demonstrates improved physical stability since freshly made without having to require a high level of organic solvents. By contrast, the comparative composition that comprises a cationic anti-microbial agent instead (Comparative Example 2B) is unstable, particularly when following a freeze thaw cycle. Different from the nonionic anti-microbial agent used for the present invention, such cationic anti-microbial agents typically require a relatively high level of organic solvents to maintain desired stability.

Unless otherwise indicated, all percentages, ratios, and proportions are calculated based on weight of the total composition. All temperatures are in degrees Celsius (° C.) unless otherwise indicated. All measurements made are at 25° C., unless otherwise designated. All component or composition levels are in reference to the active level of that component or composition, and are exclusive of impurities, for example, residual solvents or by-products, which may be present in commercially available sources.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid anti-microbial laundry detergent composition, comprising:
a) from about 0.001% to about 3%, by weight of the composition, of a nonionic anti-microbial agent; and
b) from about 0.1% to about 2.5%, by weight of the composition, of an organic solvent, wherein said organic solvent is a C₁-C₆ alcohol.

2. The composition according to claim 1, further comprising from about 3% to about 50%, by weight of the composition, of an anionic surfactant.

3. The composition according to claim 1, wherein said nonionic anti-microbial agent is a diphenyl ether.

4. The composition according to claim 3, wherein said nonionic anti-microbial agent is a hydroxyl diphenyl ether compound of formula (I): 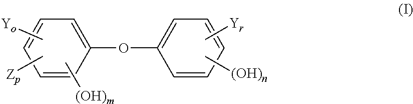
wherein:
each Y is independently selected from chlorine, bromine, or fluorine,
each Z is independently selected from SO₂H, NO₂, or C₁-C₄ alkyl,
r is 0, 1, 2, or 3,
o is 0, 1, 2, or 3,
p is 0, 1, or 2,
m is 1 or 2, and
n is 0 or 1.

5. The composition according to claim 4, wherein said nonionic anti-microbial agent is selected from the group consisting of 4-4′-dichloro-2-hydroxy diphenyl ether, 2,4,4′-trichloro-2′-hydroxy diphenyl ether, and a combination thereof.

6. The composition according to claim 5, wherein said nonionic anti-microbial agent is 4-4′-dichloro-2-hydroxy diphenyl ether.

7. The composition according to claim 1, wherein said organic solvent is selected from the group consisting of ethanol, ethylene glycol, diethylene glycol, propylene glycol, glycerol, ethanolamine, and a combination thereof.

8. The composition according to claim 1, wherein said nonionic anti-microbial agent is present from about 0.01% to about 1%, by weight of the composition, and said organic solvent is present from about 0.2% to about 2%, by weight of the composition.

9. The composition according to claim 1, comprising:
a) from about 0.03% to about 0.5%, by weight of the composition, of said nonionic anti-microbial agent, wherein said nonionic anti-microbial agent is 4-4′-dichloro-2-hydroxy diphenyl ether;
b) from about 0.3% to about 1.5%, by weight of the composition, of said organic solvent, wherein said organic solvent is a propylene glycol;
c) from about 10% to about 40%, by weight of the composition, of an anionic surfactant, wherein said anionic surfactant is selected from the group consisting of an alkyl ethoxy sulfate (AES), a linear alkylbenzene sulfonate (LAS), and a combination thereof; and
d) from about 0.5% to about 5%, by weight of the composition, of a nonionic surfactant, wherein said nonionic surfactant is C₁₂-C₁₆ alcohol ethoxylated with an average of 5 to 9 moles of ethylene oxides.

10. The composition according to claim 1, wherein the composition is contained within a water-soluble film, preferably said water-soluble film comprises polyvinyl alcohol.
